(19) United States
(12) Patent Application Publication
(10) Pub. No.: US 2023/0159786 A1
(43) Pub. Date: May 25, 2023

(54) USE OF COATING COMPOSITIONS FOR MAKING A SUBSTRATE FROST RESISTANT, COMPOSITIONS AND METHODS USEFUL THEREFOR

(71) Applicant: Solvay SA, Brussels (BE)

(72) Inventors: Congyu Bao, Shanghai (CN); Yunjiao Gu, Shanghai (CN); Bing Hong, Shanghai (CN); Chunying Liu, Shanghai (CN); Peng Xu, Singapore (SG)

(73) Assignee: Solvay SA, Brussels (BE)

(21) Appl. No.: 17/919,227

(22) PCT Filed: Apr. 15, 2020
(86) PCT No.: PCT/CN2020/084848

§ 371 Date: Oct. 14, 2022

(51) Int. Cl. C09D 133/14; C09D 7/65; C09D 7/20

(52) U.S. Cl. CPC C09D 133/14; C09D 7/65; C09D 7/20

(57) ABSTRACT

Use of a coating composition for making a frost resistant substrate, the coating composition comprises at least one copolymer (ZW-CA) comprising: (a) repeating units (RZW) derived from at least one zwitterionic monomer, monomer (B), and (b) repeating units (RCA) derived from at least one monomer containing carboxylic acid and/or carboxylic anhydride, monomer (B), and at least one crosslinking agent (CL).

The present invention relates to the field of coating compositions and methods for making a substrate frost resistant.

Frosting happens when the surface temperature is below both water freezing temperature and air dew point temperature. In other words, the frost starts to form when the contact happens between the cold surface and the near water vapor in the air due to the temperature difference. Frosting is a common natural phenomenon on cold surface. Ice formation on surfaces is responsible for economic losses in many fields such as aviation, ground transportation, power transmission, communication and refrigeration. In our daily life, frosting on cold surface lowers the operating efficiency of heating or refrigerating equipment and causes huge energy waste e.g. —frosting of heat exchangers of air conditionings, —frosting of refrigerators . . . . Because frost layer has thermal isolating properties, frost layer on a surface of refrigerating equipment impairs the heat transfer efficiency of the equipment and narrows or even blocks the airflow channel, thereby resulting in important energy waste.

Current anti-frosting surface modification technologies proceed in three general directions: superhydrophobic hydrophilic slippery surfaces and polymeric hydrophilic coatings. Superhydrophobic coating, typically nanocomposite coatings, usually suffers durability problem. Therefore, it is still technically challenging for the industry to produce superhydrophobic coatings with long-lasting frost-resisting performance. In recent years hydrophilic slippery surfaces emerge as a new type of anti-frosting technology with increasing attention from researchers worldwide. With this technology, water drops spread and remove from the hydrophilic slippery surface. While promising, the technology is expensive and durability is still to be improved. Development of polymeric hydrophilic coating, typically containing hydroxyl acrylates, is the priority for the industry now, due to its facile fabrication process and easy access to lhydrophilic resins. However frost-resisting performance remains unsatisfying and some improvement are still highly desirable.

Among hydrophilic polar chemical groups, zwitterions are known to be highly hygroscopic. U.S. Pat. No. 4,328,143 discloses an aqueous coating composition for formation of a coating film having high corrosion-resistance on a metal substrate which comprises (a) a film-forming polymeric material having at least one hydroxyl group and/or at least one carboxyl group, (b) a zwitter-ion compound and (c) an aminoplast resin and/or an epoxy resin with or without (d) a surface active agent having a hydrophilic functional group and at least one hydroxyl group and/or at least one carboxyl group. The role of such zwitter-ion compound may be considered to be as (1) serving as an acid catalyst in the crosslinking reaction; and (2) improving the hydrophilic property. However, the coating composition described showed limited improvement of initial surface wettability and the stability of resulting films was low. Nothing is said about frost resistance of the coated surface.

Thus, there is an ongoing need for new or improved coating compositions for making frost resistant a substrate. There is also a need for these coating compositions to provide durable coatings that are resistant to weathering and to scratch. There is still a need for the coating compositions to provide coatings that make substrates resistant to corrosion when said substrates are submitted to corrosive environments. Finally, there is a need for these coating compositions to durably guaranty the heat transfer efficiency of coated equipment, e.g. heating or refrigerating equipment, resulting in important energy saving.

All these needs and others are fulfilled by the different aspects of the present invention.

### SUMMARY OF THE INVENTION

In a first aspect, the present disclosure relates to the use of a coating composition (C) comprising.
at least one copolymer [copolymer (ZW-CA)] comprising
(a) repeating units [units (R_{ZW})] derived from at least one zwitterionic monomer [monomer (A)], and
(b) repeating units [units (R_{CA})] derived from at least one carboxylic acid and/or carboxylic anhydride containing monomer [monomer (B)], and
at least one crosslinking agent [crosslinking agent (CL)],
   for making frost resistant a substrate.

Without wishing to be bound to theory, adding specific amount of zwitterionic monomer to the polymer comprising repeating units derived from carboxylic acid and/or carboxylic anhydride containing monomer, results in a significant improvement of anti-frosting performance of the entire coating.

In a second aspect, the present disclosure relates to a method for making frost resistant a substrate, the method comprising processing a composition (C) as previously described onto the substrate thereby providing a top coating layer (TL) effective to make said substrate frost resistant.

In a third aspect, the present disclosure relates to an article comprising a metal or metal-containing surface, wherein the metal or metal-containing surface is coated with the coating composition (C) thereby providing a top coating layer (TL) effective to make said surface frost resistant.

In a fourth aspect, the present disclosure relates to an article comprising a metal or metal-containing surface coated with the top coating layer (TL), wherein a base coating layer (BL) is sandwiched between the metal or metal-containing surface and the top coating layer (TL).

In a fifth aspect, the present disclosure relates to a coating composition (C) comprising.
at least one copolymer (ZW-CA) comprising
   (a) repeating units (R_{ZW}) derived from at least one zwitterionic monomer (A), and
   (b) repeating units (R_{CA}) derived from at least one carboxylic acid and/or carboxylic anhydride containing monomer (B), and
at least one crosslinking agent (CL),
   wherein said crosslinking agent (CL) is a polyol.

### BRIEF DESCRIPTION OF DRAWINGS

FIG. 1 is a picture of the facility employed to measure heat exchange capacity (Q).

### DETAILED DESCRIPTION

As used herein, the terms “a”, “an”, or “the” means “one or more” or “at least one” unless otherwise stated.

As used herein, the term “comprises” includes “consists essentially of” and “consists of.” The term “comprising” includes “consisting essentially of” and “consisting of.”

Throughout the present disclosure, various publications may be incorporated by reference. Should the meaning of any language in such publications incorporated by reference conflict with the meaning of the language of the present disclosure, the meaning of the language of the present disclosure shall take precedence, unless otherwise indicated.

The present disclosure relates to the use of a composition comprising:
at least one copolymer [copolymer (ZW-CA)] comprising
(a) repeating units [units (R_{ZW})] derived from at least one zwitterionic monomer [monomer (A)], and
(b) repeating units [units (R_{CA})] derived from at least one carboxylic acid and/or carboxylic anhydride containing monomer [monomer (B)], and
at least one crosslinking agent [crosslinking agent (CL)],
   for making frost resistant a substrate.

In accordance with the present disclosure, a substrate resisting the frost refers to partial or complete inhibition of the frost on a surface of said substrate.

Resistance also includes slowing down frosting on a surface.

As used herein, the term “frost” is a thin layer of ice on a solid surface, which forms from water vapor in an above freezing atmosphere coming in contact with a solid surface whose temperature is below freezing, and resulting in a phase change from water vapor (a gas) to ice (a solid) as the water vapor reaches the freezing point.

Without wishing to be bound to theory, the formation of frost is believed to be delayed by the disrupted water crystallization on charged surfaces. Frosting, occurred on foreign hygroscopic surfaces, is described as heterogeneous ice nucleation (HIN). HIN on charged surfaces is believed to be affected by the interfacial water structure, and is also dependent on the amount of surface charges.

The copolymer (ZW-CA) of the present disclosure comprises repeating units (R_{ZW}) derived from at least one zwitterionic monomer (A). As used herein, zwitterionic monomer (A) refers to monomer capable of polymerization. Generally, zwitterionic repeating units (R_{ZW}) are derived from at least one zwitterionic monomer (A) that is neutral in overall charge but contains a number of group (C+) equal to the number of group (A−). The cationic charge(s) may be contributed by at least one onium or inium cation of nitrogen, such as ammonium, pyridinium and imidazolinium cation; phosphorus, such as phosphonium; and/or sulfur, such as sulfonium. The anionic charge(s) may be contributed by at least one carbonate, sulfonate, phosphate, phosphonate, phosphinate or ethenolate anion, and the like. Suitable zwitterionic monomers include, but are not limited to, betaine monomers, which are zwitterionic and comprise an onium atom that bears no hydrogen atoms and that is not adjacent to the anionic atom. Suitable zwitterionic monomers include, but are not limited to ethylenically unsaturated monomer having at least two ionic groups, at least one of them being a cationic group [group (C+)] and at least one of them being an anionic group [group (A−)].

In some embodiments, units (R_{ZW}) are derived from at least one monomer (A) selected from the list consisting of
a) alkyl or hydroxyalkyl sulfonates or phosphonates of dialkylammonium alkyl acrylates or methacrylates, acrylamido or methacrylamido, typically
   sulfopropyldimethylammonioethyl (meth)acrylate,
   sulfoethyldimethylammonioethyl (meth)acrylate,
   sulfobutyldimethylammonioethyl (meth)acrylate,
   sulfohydroxypropyldimethylammonioethyl (meth)acrylate,
   sulfopropyldimethylammoniopropylacrylamide,
   sulfopropyldimethylammoniopropylmethacrylamide,
   sulfohydroxypropyldimethylammoniopropyl(meth)acrylamide,
   sulfopropyldiethylammonio ethoxyethyl methacrylate.
b) heterocyclic betaine monomers, typically
   sulfobetaines derived from piperazine,
   sulfobetaines derived from 2-vinylpyridine and 4-vinylpyridine, more typically 1-(3-Sulphonatopropyl)-2-vinylpyridinium or 1-(3-Sulphonatopropyl)-4-vinylpyridinium,
   1-vinyl-3-(3-sulfopropyl)imidazolium betaine;
c) alkyl or hydroxyalkyl sulfonates or phosphonates of dialkylammonium alkyl allylics, typically sulfopropylmethyldiallylammonium betaine;
d) alkyl or hydroxyalkyl sulfonates or phosphonates of dialkylammonium alkyl styrenes;
e) betaines resulting from ethylenically unsaturated anhydrides and dienes;
f) phosphobetaines of formulae

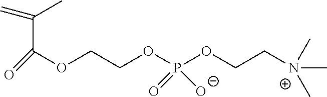 [SMILES: C=C(C)C(=O)OCCOP(=O)([O-])OCC[N+](C)(C)C]

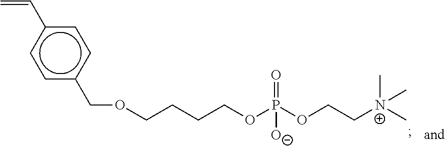

g) betaines resulting from cyclic acetals, typically ((dicyanoethanolate)ethoxy)dimethylammoniopropylmethacrylamide.

In some preferred embodiments, units (R_{ZW}) are derived from at least one monomer (A) selected from the list consisting of
sulfopropyldimethylammonioethyl acrylate,
sulfopropyldimethylammonioethyl methacrylate (SPE),

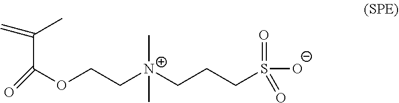 [SMILES: C=C(C)C(=O)OCC[N+](C)(C)CCCS(=O)(=O)[O-]]

sulfopropyldimethylammoniopropyl acrylamide,
sulfopropyldimethylammoniopropyl methacrylamide,
sulfohydroxypropyldimethylammonioethyl acrylate,
sulfohydroxypropyldimethylammonioethyl methacrylate (SHPE),
sulfohydroxypropyldimethylammoniopropyl acrylamide (AHPS),
sulfohydroxypropyldimethylammoniopropyl methacrylamide (SHPP)
1-(3-Sulphonatopropyl)-2-vinylpyridinium (2SPV), and

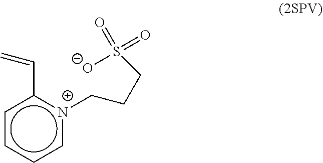

1-(3-Sulphonatopropyl)-4-vinylpyridinium (4SPV).

In some more preferred embodiments, units (R_{ZW}) are derived from at least one monomer (A) selected from the list consisting of
sulfopropyldimethylammonioethyl acrylate,
sulfopropyldimethylammonioethyl methacrylate (SPE),
1-(3-Sulphonatopropyl)-2-vinylpyridinium, and
1-(3-Sulphonatopropyl)-4-vinylpyridinium.

In some even more preferred embodiments, units (R_{ZW}) are derived from sulfopropyldimethylammonioethyl methacrylate (SPE).

Copolymer (ZW-CA) according to the disclosure, besides comprising repeating units (R_{ZW}) derived from at least one zwitterionic monomer (A), also comprises repeating units (R_{CA}) derived from at least one at least one carboxylic acid and/or carboxylic anhydride containing monomer (B).

Generally, monomer (B) is selected from the list consisting of acrylic acid, methacrylic acid, maleic acid, maleic acid anhydride, itaconic acid, crotonic acid, fumaric acid, 4-methacryloxyethyltrimellitic acid, 4-methacryloxyethyltrimellitic acid anhydride and methacryloyl-L-Lysine. Preferably, monomer (B) is selected from the list consisting of acrylic acid, methacrylic acid, maleic acid and maleic acid anhydride. More preferably, monomer (B) is selected from the list consisting of acrylic acid, methacrylic acid and maleic acid; more preferably monomer (B) is acrylic acid or methacrylic acid.

In some preferred embodiments, the copolymer (ZW-CA) of the present disclosure comprises repeating units (R_{ZW}) derived from sulfopropyldimethylammonioethyl methacrylate (SPE) and repeating units (R_{CA}) derived from at least one monomer (B) selected from the list consisting of acrylic acid, methacrylic acid, maleic acid and maleic acid anhydride.

In some more preferred embodiments, the copolymer (ZW-CA) of the present disclosure comprises repeating units (R_{ZW}) derived from sulfopropyldimethylammonioethyl methacrylate (SPE) and repeating units (R_{CA}) derived from acrylic acid or methacrylic acid.

Still in some more preferred embodiments, the copolymer (ZW-CA) of the present disclosure substantially comprises, substantially consists of, or consists of, repeating units (R_{ZW}) derived from sulfopropyldimethylammonioethyl methacrylate (SPE) and repeating units (R_{CA}) derived from acrylic acid or methacrylic acid.

Substantially comprising or substantially consisting of as used herein means at least 90%, preferably at least 95%, more preferably at least 97%. e.g. at least 98%. Percentages given herein are % by weight, based on the total weight of the copolymer (ZW-CA).

In some embodiments, copolymer (ZW-CA) according to the disclosure further comprises repeating units [units (R_{N})], different from units (R_{ZW}) and units (R_{CA}), derived from at least one monomer [monomer (D)], different from monomers A and B. Generally, monomer (D) is an ethylenically unsaturated monomer different from monomers A and B. Monomer (D) can be selected from the list consisting of methyl methacrylate, ethyl methacrylate, n-butyl methacrylate, isobutyl methacrylate, 2-ethyl hexyl methacrylate, methyl acrylate, ethyl acrylate, n-butyl acrylate, isobutyl acrylate, 2-ethyl hexyl acrylate, vinyl acetate, 2-hydroxyethyl methacrylate (HEMA), hydroxypropyl methacrylate, 2-hydroxyethyl acrylate (HEA), hydroxypropyl acrylate, 4-hydroxybutyl acrylate, poly(ethylene glycol) methacrylate (PEGMA), poly(ethylene glycol) methyl ether methacrylate (mPEGMA), poly(ethylene glycol) ethyl ether methacrylate, poly(ethylene glycol) methyl ether acrylate and poly(ethylene glycol) ethyl ether acrylate.

Preferably monomer (D) is 2-hydroxyethyl methacrylate (HEMA), 2-hydroxyethyl acrylate (HEA) or mixtures thereof. More preferably, monomer (D) is 2-hydroxyethyl methacrylate (HEMA).

Still in some preferred embodiments, the copolymer (ZW-CA) of the present disclosure comprises repeating units (R_{ZW}) derived from (SPE), repeating units (R_{CA}) derived from at least one monomer (B) selected from the list consisting of acrylic acid, methacrylic acid, maleic acid and maleic acid anhydride and repeating units (R_{N}) derived from 2-hydroxyethyl methacrylate (HEMA), 2-hydroxyethyl acrylate (HEA) or mixtures thereof.

In some preferred embodiments, the copolymer (ZW-CA) of the present disclosure comprises repeating units (R_{ZW}) derived from (SPE), repeating units (R_{CA}) derived from acrylic acid or methacrylic acid and repeating units (R_{N}) derived from 2-hydroxyethyl methacrylate (HEMA).

The copolymer (ZW-CA) of the composition (C) according to the present disclosure generally comprises from 0.5 to 50 wt. %, preferably from 1 to 30 wt. %, more preferably from 2 to 25 wt. % and even more preferably from 3 to 20 wt. % of units (R_{ZW}), with respect to the total weight of copolymer (ZW-CA).

Besides, the copolymer (ZW-CA) of the composition (C) according to the present disclosure generally comprises 50 wt. % or more, preferably 70 wt. % or more, more preferably 75 wt. % or more and even more preferably 80 wt. % or more of units (R_{CA}), with respect to the total weight of copolymer (ZW-CA).

When repeating units (R_{N}) are present, copolymer (ZW-CA) generally comprises from 0.5 to 40 wt. %, preferably from 0.5 to 25 wt. %, more preferably from 0.5 to 20 wt. % and even more preferably from 0.5 to 15 wt. % of repeating units (R_{N}), with respect to the total weight of copolymer (ZW-CA).

When repeating units (R_{N}) are present, copolymer (ZW-CA) generally comprises from 0.5 to 40 wt. %, preferably from 0.5 to 25 wt. %, more preferably from 0.5 to 20 wt. % and even more preferably from 0.5 to 15 wt. % of repeating units (R_{ZW}), with respect to the total weight of copolymer (ZW-CA).

Besides, when repeating units (R_{N}) are present the copolymer (ZW-CA) of the composition (C) according to the present disclosure generally comprises 20 wt. % or more, preferably 50 wt. % or more, more preferably 60 wt. % or more and even more preferably 70 wt. % or more of units (R_{CA}), with respect to the total weight of copolymer (ZW-CA).

In some embodiments the copolymer (ZW-CA) of the composition (C) according to the present disclosure comprises from 0.5 to 40 wt. % of repeating units (R_{N}), from 0.5 to 40 wt. % of repeating units (R_{ZW}) and 20 wt. % or more of units (R_{CA}) with respect to the total weight of copolymer (ZW-CA).

Copolymer (ZW-CA) according to the invention is linear or branched; it is a block copolymer, a statistical copolymer, an alternating copolymer or a grafted copolymer. Good results were obtained with copolymer (ZW-CA) being a statistical copolymer.

Unless otherwise indicated, when molar mass is referred to, the reference will be to the weight-average molar mass, expressed in g/mol. The latter can be determined by gel permeation chromatography (GPC) with light scattering detection (DLS or alternatively MALLS) or refractive index detection, with an aqueous eluent, an organic eluent or mixture thereof, depending on the copolymer (ZW-CA). There is no particular limitation to the molar mass of the copolymer (ZW-CA). However, the weight-average molar mass (Mw) of the polymer (ZW-CA) is generally in the range of from about 500 to about 3,000,000 g/mol, typically from about 1,000 to about 1,000,000, g/mol, more typically from about 2,000 to 500,000 g/mol, even more typically 3,000 to 200,000 g/mol.

The copolymer (ZW-CA) of the present disclosure may be obtained by any polymerization process known to those of ordinary skill. For example, the copolymer (ZW-CA) may be obtained by radical polymerization or controlled radical polymerization in aqueous solution, in dispersed media, in organic solution or in organic/water solution (miscible phase). Just for the sake of example statistical copolymer poly(acrylic acid-stat-sulfopropyldimethylammonioethyl methacrylate) (poly(AA-stat-SPE) can be prepared by free radical copolymerization of acrylic acid and sulfopropyldimethylammonioethyl methacrylate in water initiated by sodium or ammonium persulfate. Still for the sake of example statistical copolymer poly(maleic anhydride-stat-3-(dimethyl(4-vinylbenzyl)ammonio)propane-1-sulfonate) can be prepared by free radical copolymerization in water of maleic anhydride and dimethyl(4-vinylbenzyl)ammonio)propane-1-sulfonate initiated by 4,4′-azobis(4-cyanovaleric acid) (ACVA).

The monomer (B) from which can be derived units (R_{CA}) may be obtained from commercial sources.

The monomer (D) from which can be derived units (R_{N}) may be obtained from commercial sources.

The zwitterionic monomer (A) from which are derived units (R_{ZW}) may be obtained from commercial sources or synthesized according to methods known to those of ordinary skill in the art.

Suitable zwitterionic monomers (A) from which can be derived units (R_{ZW}) include, but are not limited to monomers selected from the list consisting of:
a) alkyl or hydroxyalkyl sulfonates or phosphonates of dialkylammonium alkyl acrylates or methacrylates, acrylamido or methacrylamido, typically:
sulfopropyldimethylammonioethyl methacrylate, sold by Raschig under the name RALU®MER SPE

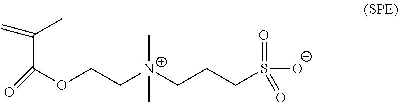 [SMILES: C=C(C)C(=O)OCC[N+](C)(C)CCCS(=O)(=O)[O-]]

sulfoethyldimethylammonioethyl methacrylate,

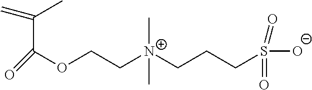 [SMILES: C=C(C)C(=O)OCC[N+](C)(C)CCCS(=O)(=O)[O-]]

sulfobutyldimethylammonioethyl methacrylate:

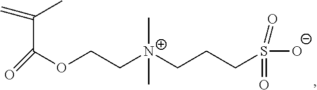 [SMILES: C=C(C)C(=O)OCC[N+](C)(C)CCCS(=O)(=O)[O-]]

the synthesis of which is described in the paper “Sulfobetaine zwitterionomers based on n-butyl acrylate and 2-ethoxyethyl acrylate: monomer synthesis and copolymerization behavior”, Journal of Polymer Science, 40, 511-523 (2002),
sulfohydroxypropyldimethylammonioethyl methacrylate,

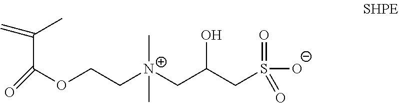 [SMILES: C=C(C)C(=O)OCC[N+](C)(C)CC(O)CS(=O)(=O)[O-]]

and other hydroxyalkyl sulfonates of dialkylammonium alkyl acrylates or methacrylates, acrylamido or methacrylamido of formulae below

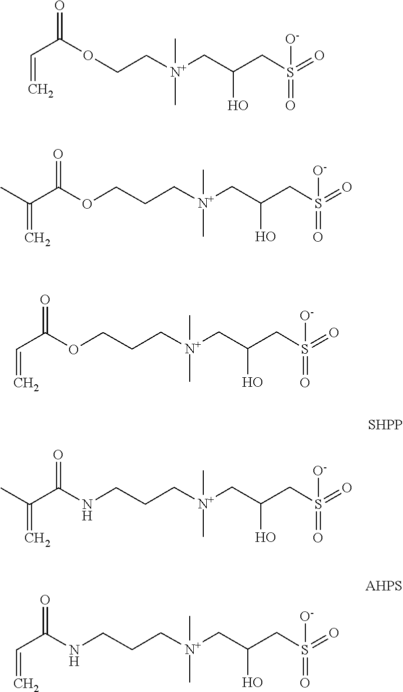 [SMILES: C=CC(=O)OCC[N+](C)(C)CC(O)CS(=O)(=O)[O-] ; C=C(C)C(=O)OCCC[N+](C)(C)CC(O)CS(=O)(=O)[O-] ; C=CC(=O)OCCC[N+](C)(C)CC(O)CS(=O)(=O)[O-] ; C=C(C)C(=O)NCCC[N+](C)(C)CC(O)CS(=O)(=O)[O-] ; C=CC(=O)NCCC[N+](C)(C)CC(O)CS(=O)(=O)[O-]]

sulfopropyldimethylammoniopropylacrylamide,
   the synthesis of which is described in the paper “Synthesis and solubility of the poly(sulfobetaine)s and the corresponding cationic polymers: 1. Synthesis and characterization of sulfobetaines and the corresponding cationic monomers by nuclear magnetic resonance spectra”, Wen-Fu Lee and Chan-Chang Tsai, Polymer, 35 (10), 2210-2217 (1994),
sulfopropyldimethylammoniopropylmethacrylamide, sold by Raschig under the name SPP:

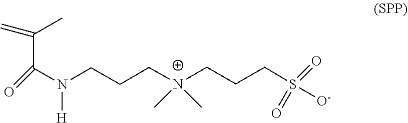 [SMILES: C=C(C)C(=O)NCCC[N+](C)(C)CCCS(=O)(=O)[O-]]

sulfopropyldiethylammonio ethoxyethyl methacrylate:

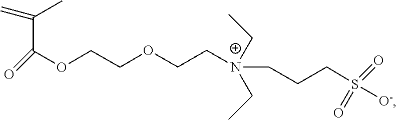

the synthesis of which is described in the paper “Poly(sulphopropylbetaines): 1. Synthesis and characterization”, V. M. Monroy Soto and J. C. Galin, Polymer, 1984, Vol. 25, 121-128;
b) heterocyclic betaine monomers, typically:
sulfobetaines derived from piperazine having any one of the following structures

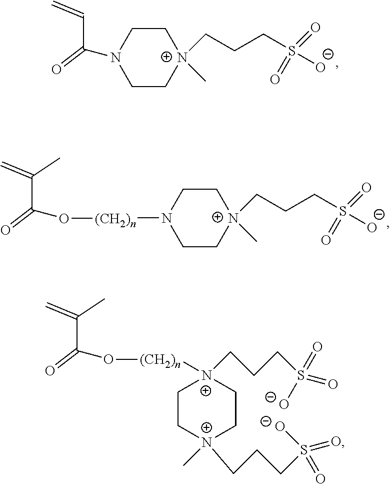

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994), and other hydroxyalkyl sulfonates derived from piperazine of formulae below

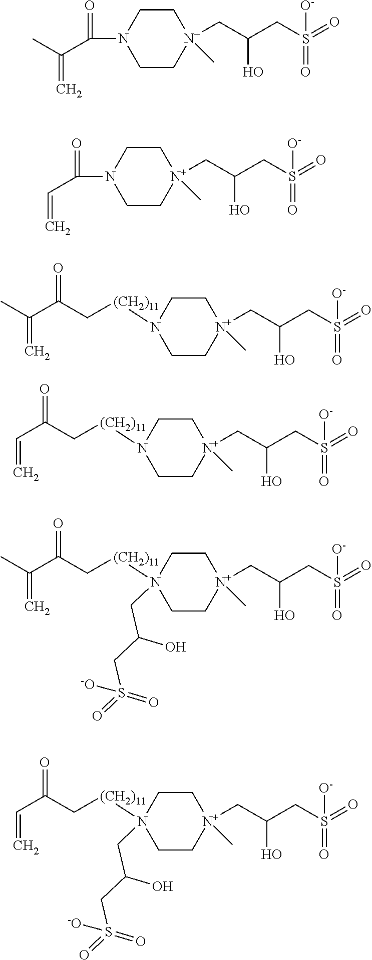

sulfobetaines derived from 2-vinylpyridine and 4vinylpyridine, such as 2-vinyl-1-(3-sulfopropyl)pyridinium betaine (2SPV), sold by Raschig under the name SPV:

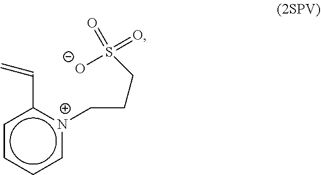

and 4-vinyl-1-(3-sulfopropyl)pyridinium betaine (4SPV),

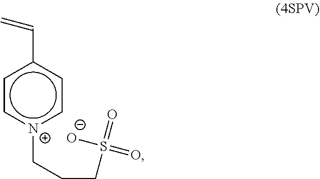

the synthesis of which is disclosed in the paper “Evidence of ionic aggregates in some ampholytic polymers by transmission electron microscopy”, V. M. Castaño and A. E. González, J. Cardoso, O. Manero and V. M. Monroy, J. Mater. Res., 5 (3), 654-657 (1990), and other hydroxyalkyl sulfonates derived from 2-vinylpyridine and 4vinylpyridine of formulae below

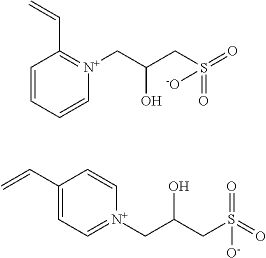

1-vinyl-3-(3-sulfopropyl)imidazolium betaine:

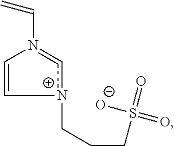

the synthesis of which is described in the paper “Aqueous solution properties of a poly(vinyl imidazolium sulphobetaine)”, J. C. Salamone, W. Volkson, A. P. Oison, S. C. Israel, Polymer, 19, 1157-1162 (1978), and corresponding hydroxyalkylsulfonate of formula below

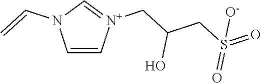

c) alkyl or hydroxyalkyl sulfonates or phosphonates of dialkylammonium alkyl allylics, typically sulfopropylmethyldiallylammonium betaine:

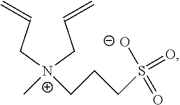

the synthesis of which is described in the paper “New poly(carbobetaine)s made from zwitterionic diallylammonium monomers”, Favresse, Philippe; Laschewsky, Andre, Macromolecular Chemistry and Physics, 200(4), 887-895 (1999),
d) alkyl or hydroxyalkyl sulfonates or phosphonates of dialkylammonium alkyl styrenes, typically compounds having any one of the following structures:

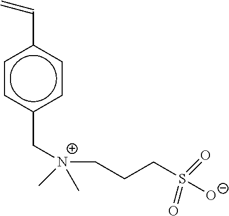

3-(dimethyl(4-vinylbenzyl)ammonio)propane-1-sulfonate,

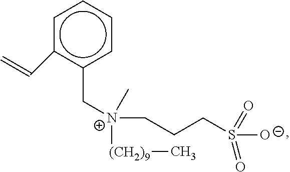

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994), and other hydroxyalkyl sulfonates of dialkylammonium alkyl styrenes of formulae below

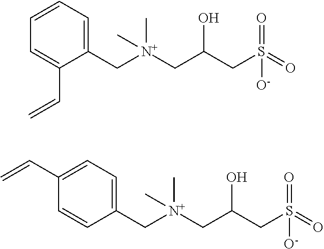

e) betaines resulting from ethylenically unsaturated anhydrides and dienes, typically compounds having any one of the following structures:

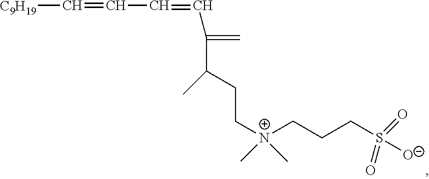

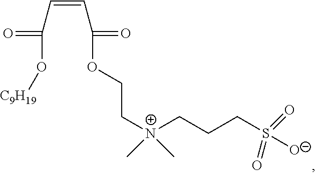

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
f) phosphobetaines having any one of the following structures:

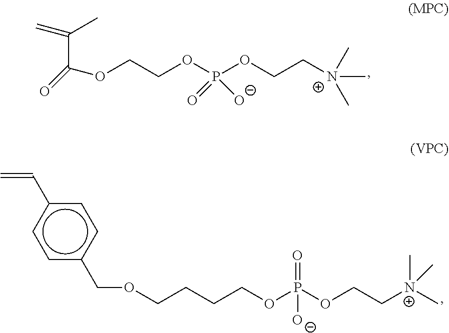

the synthesis of which are disclosed in EP 810 239 B1 (Biocompatibles, Alister et al.);
g) betaines resulting from cyclic acetals, typically ((dicyanoethanolate)ethoxy)dimethylammoniumpropylmethacrylamide:

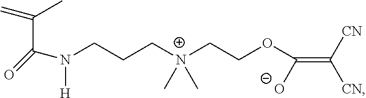 [SMILES: C=C(C)C(=O)NCCC[N+](C)(C)CCOC([O-])=C(C#N)C#N]

the synthesis of which is described by M-L. Pujol-Fortin et al. in the paper entitled “Poly(ammonium alkoxydicyanatoethenolates) as new hydrophobic and highly dipolar poly(zwitterions). 1. Synthesis”, Macromolecules, 24, 4523-4530 (1991).

Suitable monomers comprising hydroxyalkyl sulfonate moieties from which can be derived units (R_{ZW}) can be obtained by reaction of sodium 3-chloro-2-hydroxypropane-1-sulfonate (CHPSNa) with monomer bearing tertiary amino group, as described in US20080045420 for the synthesis of SHPP, starting from dimethylaminopropylmethacrylamide according to the reaction scheme

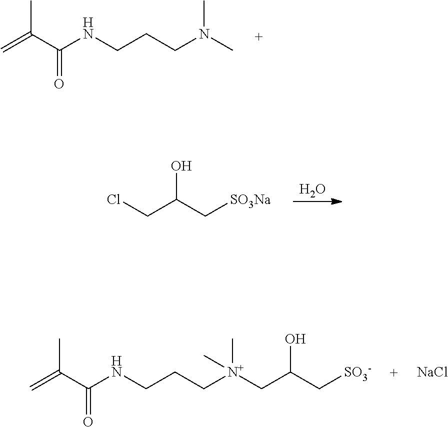

Other monomers bearing tertiary amino group may be involved in reaction with CHPSNa to obtain suitable monomers from which are derived units (R_{ZW}):

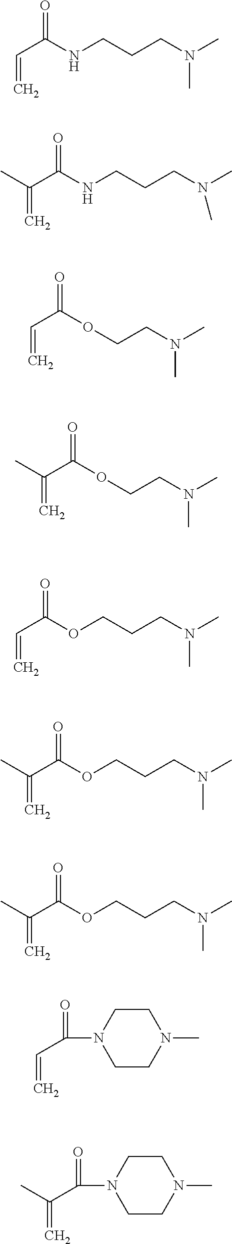

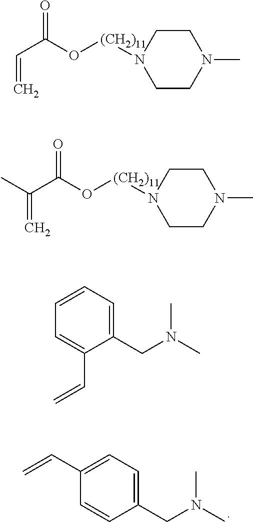

Suitable monomers from which are derived units (R_{ZW}) may be also obtained by reaction of sodium 3-chloro-2-hydroxypropane-1-sulfonate (CHPSNa) with monomer bearing pyridine or imidazole group:

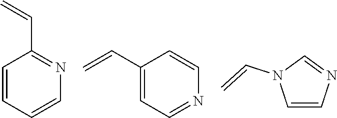

The expression “derived from” which puts repeating units (R_{ZW}) in connection with a monomer is intended to define both repeating units (R_{ZW}) directly obtained from polymerizing the said monomer, and the same repeating units (R_{ZW}) obtained by modification of an existing polymer.

Accordingly, repeating units (R_{ZW}) may be obtained by modification of a polymer referred to as a precursor polymer comprising repeating units bearing tertiary amino groups through the reaction with sodium 3-chloro-2-hydroxypropane-1-sulfonate (CHPSNa). Similar modification was described in WO2008125512 with sodium 3-chloropropane-1-sulfonate in place of CHPSNa:

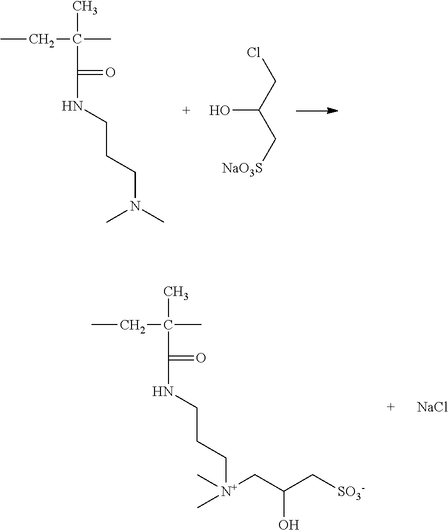

Finally, repeating units (R_{ZW}) may be obtained by chemical modification of a polymer referred to as a precursor polymer with a sultone, such as propane sultone or butane sultone, a haloalkylsulfonate or any other sulfonated electrophilic compound known to those of ordinary skill in the art. Exemplary synthetic steps are shown below:

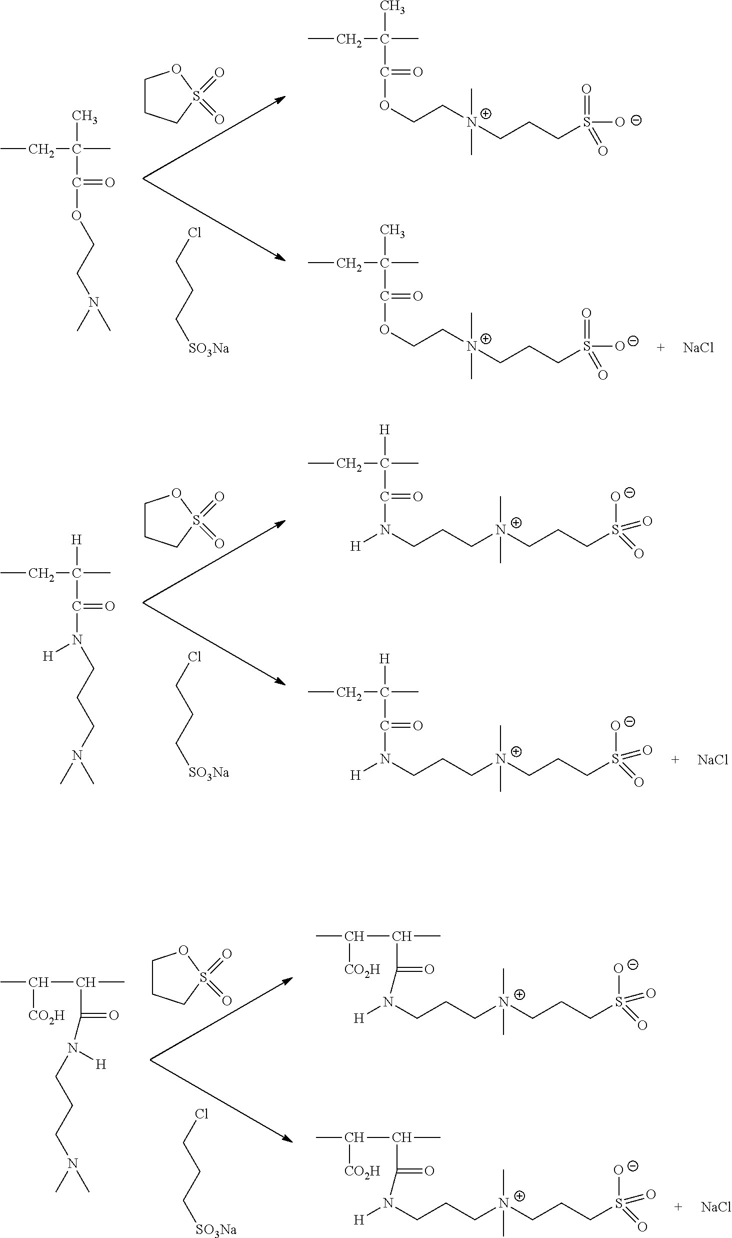

Similarly, repeating units (R_{ZW}) may be obtained by modification of a polymer referred to as a precursor polymer comprising repeating units bearing tertiary amino groups, pyridine groups, imidazole group or mixtures thereof through the reaction with sodium 3-chloro-2-hydroxypropane-1-sulfonate (CHPSNa), a sultone, such as propane sultone or butane sultone, or a haloalkylsulfonate.

The composition (C) according to the present disclosure also comprises at least one crosslinking agent (CL).

Crosslinking agent (CL) may be polymeric compound or small molecule. Suitable crosslinking agent is generally a molecular structure comprising 2 or more functional groups, said functional groups being capable to react with carboxylic acid groups of the copolymer (ZW-CA). Generally the crosslinking agent (CL) is selected from the list consisting of polyols, polyamines, polyepoxides, polyisocyanates, blocked polyisocyanates, polycarbodiimides and mixtures thereof.

By polyol crosslinking agent suitable for the invention is meant molecular structure comprising 2 or more hydroxyl groups. Generally, polyol is selected from the list consisting of polyvinyl alcohol polymers i.e. homopolymers or copolymers, ethylene glycol, diethylene glycol, propylene glycol, neopentyl glycol, neopentyl glycol hydroxypivalate, cyclohexanedimethanol, butane-1,4-diol, pentane-1,5-diol, pentane-1,2-diol, hexane-1,6-diol, nonane-1,9-diol, glycerol, polyglycerol, trimethylolpropane, trimethylolpropane dimer, pentaerythritol, di pentaerythritol, xylitol, sorbitol, hydroxyalkylamides such as N,N,N′,N′-tetrakis(2-hydroxyethyl)hexanediamide, N,N,N′,N′-tetrakis(2-hydroxypropyl)hexanediamide, N,N,N′,N′-tetrakis(2-hydroxyethyl)butanediamide, N,N,N′,N′-tetrakis(2-hydroxypropyl)butanediamide, triethanolamine, triisopropanolamine, N,N,N′,N′-tetrakis(2-hydroxyethyl)ethylenediamine, N,N,N′,N′-tetrakis(2-hydroxypropyl)ethylenediamine, trimethylol melamine, dimethylolurea, 1,1,3-tris(hydroxymethyl)urea, 1,1,3,3-tetrakis(hydroxymethyl)urea, alkoxylated polyols such as pentaerythritol ethoxylate, pentaerythritol propoxylate, and mixtures thereof. Good results were obtained using N,N,N′,N′-tetrakis(2-hydroxyethyl)hexanediamide. Just for the sake of example, a suitable commercially available polyol is VESTAGON® EP-HA320 available from Evonik.

By polyamine crosslinking agent suitable for the invention is meant molecular structure comprising 2 or more amine groups. Generally polyamine is selected from the list consisting of polyoxypropylene diamine, 1,2-ethylenediamine, 1,2-propylenediamine, 1,3-propylenediamine, 1,2-butylenediamine, 1,3-butylenediamine, 1,4-butylenediamine, 2-(ethylamino)ethylamine, 3-(methylamino)propylamine, 3-(cyclohexylamino)propylamine, 4,4′-diaminodicyclohexylmethane, hexamethylenediamines, trimethylhexamethylenediamine, 4,7-dioxadecane-1,10-diamine, N-(2-aminoethyl)-1,2-ethanediamine, N-(3-aminopropyl)-1,3-propanediamine, N, N′-1,2-ethanediylbis(1,3-propanediamine), diethylenetriamine, dipropylenetriamine, triethylenetetramine, tetraethylenepentamine, 4-aminomethyl-1,8-octanediamine, 4,4-diaminodicyclohexylmethane (PACM), 4,4′-methylenedianiline (MDA), m-xylenediamine, isophorone diamine (IPD), 4,4′-diaminodiphenyl sulfone, 4,4′-diaminodiphenyl ether, melamine, 4,4′-methylenebis(cyclohexylamine)carbamate, and mixtures thereof.

By polyepoxide crosslinking agent suitable for the invention is meant molecular structure comprising 2 or more epoxide groups. Suitable polyepoxide can be selected from the list consisting of 1,6-hexanediol diglycidyl ether, 1,4-butanediol diglycidyl ether, neopentyl glycol diglycidyl ether, resorcinol diglycidyl ether, trimethylolpropane triglycidyl ether, tris(4-hydroxyphenyl)methane triglycidyl ether, bisphenol A diglycidyl ether, bis[4-(glycidyloxy)phenyl]methane, bis[4-(diglycidylamino)phenyl]methane and mixtures thereof.

By polyisocyanate crosslinking agent suitable for the invention is meant molecular structure comprising 2 or more isocyanate groups. Generally polyisocyanate is selected from the list consisting of isophorone diisocyanate (IPDI), 1,4-phenylenedisocyanate, 1,4-diisocyanatobutane, hexane diisocyanates such as 1,6-diisocyanatohexane (HDI) and 1,5-diisocyanato-2-methylpentane (MPDI), 4,4′-methylenebis(cyclohexylisocyanate) (HMDI), heptane diisocyanates, octane diisocyanates, nonane diisocyanates such as 1,6-diisocyanato-2,4,4-trimethylhexane and 1,6-diisocyanato-2,2,4-trimethylhexane (TMDI), decane diisocyanates, undecane diisocyanates, dodecane diisocyanates, 4,4′-methylenebis(phenylisocyanate) (4,4′-MDI), 2,4-toluene diisocyanate (2,4-TDI), 2,6-toluene diisocyanate (2,6-TDI), 2,5(2,6)-bis(isocyanatomethyl)bicyclo[2.2.1]heptane (NBDI), 1,3-bis(isocyanatomethyl)cyclohexane (1,3-H₆-XDI), 1,4-bis(isocyanatomethyl)cyclo-hexane (1,4-H₆-XDI), nonane triisocyanates such as 4-isocyanatomethyl-1,8-octane diisocyanate (TIN), decane triisocyanates, undecane triisocyanates, dodecane triisocyanates and mixtures thereof.

In some embodiments, polyisocyanate suitable for the invention is blocked. The term block isocyanate group refers to a functional group that breaks down to form an isocyanate group and a blocking compound. Examples of blocking compounds that may be used to prepare blocked isocyanates include, but are not limited to, phenols, alcohols, oximes such as, but not limited to, those obtained from methyl ethyl ketone, acetone and didisopropyl ketone, imidazole, 1,2-pyrazole, 3,5-dimethyl pyrazole (DMP), 1,2,4-triazole, benzotriazole, 6-caprolactam, ethyl acetoacetate and diethyl malonate. Upon heating blocked isocyanate group is unblocked to produce reactive isocyanate group that will react with carboxylic acid functionality on the polymeric backbone to give amide bound after CO₂ elimination. Because the rate at which unblocked isocyanate crosslinking agents unblock to produce reactive isocyanate varies depending on the reactivity and steric factors associated with the blocking group and the isocyanate group, curing temperatures should be adjusted based upon the particular type of isocyanate group (e.g. aliphatic or aromatic) and blocking group. Some catalysts such as dibutyltin dilaurate (DBTL), cobalt or zinc acetylacetonate, diazabicyclo [2,2,2] octane (DABCO) or tetrabutylphosphonium bicarbonate can be added for accelerating the curing rate. By suitable blocked polyisocyanate is meant molecular structure comprising 2 or more blocked isocyanate groups. Suitable blocked polyisocyanate can be obtained from polyisocyanate selected from the list previously disclosed. Just for the sake of example, a suitable commercially available blocked polyisocyanate is Bayhydur® BL XP 2706 available from Covestro, Imprafix® 2794 available from Covestro, Trixene® Aqua BI 200, Trixene® Aqua BI 201 and Trixene® Aqua BI 220 available from Lanxess, Aqualink® X, Aqualink® U and Aqualink® D-HT available from Aquaspersions, KL-1202, KL-1204, KL-1205 and KL-1206 available from Holdenchem.

By polycarbodiimide crosslinking agent suitable for the invention is meant molecular structure comprising 2 or more carbodiimide moieties.

Polycarbodiimides are generally synthesized through the reaction of polyisocyanates especially aliphatic or cycloaliphatic diisocyanates in the presence of a catalyst well known by the skilled person. In the catalytic cycle, the catalyst first reacts with an isocyanate, upon which a rearrangement occurs and carbon dioxide is liberated with formation of intermediate specie. This intermediate specie can subsequently react with another isocyanate group to give a carbodiimide moiety while the catalyst is regenerated. Examples of polyisocyanates that may be used to prepare polycarbodiimides include, but are not limited to, isophorone diisocyanate (IPDI), 1,4-phenylenedisocyanate, 1,4-diisocyanatobutane, hexane diisocyanates such as 1,6-diisocyanatohexane (HDI) and 1,5-diisocyanato-2-methylpentane (MPDI), 4,4′-methylenebis(cyclohexylisocyanate) (HMDI), heptane diisocyanates, octane diisocyanates, nonane diisocyanates such as 1,6-diisocyanato-2,4,4-trimethylhexane and 1,6-diisocyanato-2,2,4-trimethylhexane (TMDI), decane diisocyanates, undecane diisocyanates, dodecane diisocyanates, 4,4′-methylenebis(phenylisocyanate) (4,4′-MDI), 2,4-toluene diisocyanate (2,4-TDI), 2,6-toluene diisocyanate (2,6-TDI), 2,5(2,6)-bis(isocyanatomethyl)bicyclo[2.2.1]heptane (NBDI), 1,3-bis(isocyanatomethyl)cyclohexane (1,3-H₆-XDI), 1,4-bis(isocyanatomethyl)cyclo-hexane (1,4-H₆-XDI), nonane triisocyanates such as 4-isocyanatomethyl-1,8-octane diisocyanate (TIN), decane triisocyanates, undecane triisocyanates, dodecane triisocyanates and mixtures thereof. The chain extending polycarbodiimides can be terminated e.g. by reacting with a monoisocyanate which may be alkyl, cycloalkyl, alkyl-aryl, or arylalkyl functional isocyanate, such as butylisocyanate, hexylisocyanate, octylisocyanate, undecylisocyanate, dodecylisocyanate, hexadecylisocyanate, octadecylisocyanate, cyclohexylisocyanate, phenylisocyanate, tolylisocyanate, 2-heptyl-3,4-bis(9-isocyanatononyl)-1-pentylcyclohexane or may be further functionalized by methods well known by the skilled person. Convenient catalysts for preparing polycarbodiimides from polyisocyanates are 1-ethyl-3-methyl-3-phospholene-1-oxide, 1-phenyl-3-methyl-3-phospholene 1-oxide and 1-methylphospholene-oxide. Just for the sake of example, a suitable commercially available polycarbodiimide is Picassian®XL-702, Picassian®XL-721, Picassian®XL-732 and Picassian®XL-752 available from Stahl; Permutex® XR-13-554, Permutex® XR-5508, Permutex® XR-5577 and Permutex® XR-5580 also available from Stahl.

In some preferred embodiments, the crosslinking agent (CL) is selected from polyol crosslinking agents and mixtures thereof. Preferably polyol crosslinking agent is selected from the list consisting of N,N,N′,N′-tetrakis(2-hydroxyethyl)hexanediamide, N,N,N′,N′-tetrakis(2-hydroxypropyl)hexanediamide, N,N,N′,N′-tetrakis(2-hydroxyethyl)ethylenediamine, N,N,N′,N′-tetrakis(2-hydroxypropyl)ethylenediamine and mixtures thereof. More preferably polyol crosslinking agent is N,N,N′,N′-tetrakis(2-hydroxyethyl)hexanediamide. Generally the weight ratio of crosslinking agent (CL) with copolymer (ZW-CA) ranges typically from 0.01 to 0.5, more typically from 0.05 to 0.25.

In some embodiments, the composition (C) according to the invention comprises water in an amount of at least 5 wt. % of the total weight of said composition (C); preferably of at least 10 wt. %; more preferably of at least 15 wt. % and even more preferably of at least 20 wt. %. Besides, the composition (C) according to the invention comprises water in an amount of at most 90 wt. % of the total weight of said composition (C); preferably of at most 85 wt. %; more preferably of at most 80 wt. % and even more preferably of at most 75 wt. %.

In some embodiments, the composition according to the invention comprises water in an amount ranging from 5 wt. % to 90 wt. % of the total weight of said composition (C); preferably ranging from 10 wt. % to 85 wt. %; more preferably ranging from 15 wt. % to 80 wt. % and even more preferably ranging from 20 wt. % to 75 wt. % of the total weight of said composition (C).

In some embodiments, the composition (C) comprises an overall amount of copolymer (ZW-CA) and crosslinking agent (CL) of at least 5 wt. %, more preferably of at least 10 wt. % and even more preferably of at least 15 wt. %, based on the total weight of water, copolymer (ZW-CA) and crosslinking agent (CL). Besides, the composition (C) comprises an overall amount of copolymer (ZW-CA) and crosslinking agent (CL) of at most 95 wt. %, preferably of at most 90 wt. %, more preferably at most 85 wt. % even more preferably of at most 80 wt. %, based on the total weight of water, copolymer (ZW-CA) and crosslinking agent (CL).

In some embodiments, the composition (C) comprises an overall amount of copolymer (ZW-CA) and crosslinking agent (CL) ranging from 5 wt. % to 95 wt. %; preferably ranging from 10 wt. % to 85 wt. % and more preferably ranging from 15 wt. % to 80 wt. %, based on the total weight of water, copolymer (ZW-CA) and crosslinking agent (CL).

The composition (C) according to the present disclosure may comprise additional components to facilitate application of the composition onto the substrate and/or to provide additional benefits. Additional components include, but are not limited to crosslinking catalysts, chelating agents, fillers, pH adjusting agents, viscosity modifiers, wetting agents, water, co-solvents, antifoaming agents, leveling agents, colorants, pigments, anti-corrosion agents, preservatives, optical brighteners, opacifying or pearlescent agents, and the like.

In some embodiments, the composition (C) according to the invention comprises water, wetting agents and co-solvents.

The co-solvent is generally selected from the list consisting of methanol, alcohol, isopropanol, ethylene glycol methyl ether, ethylene glycol ether, ethylene glycol butyl ether, propylene glycol methyl ether, propylene glycol ether, diethylene glycol ether and diethylene glycol butyl ether and mixtures thereof. Preferably the co-solvent is ethylene glycol butyl ether.

Wetting agent fort coating formulations is generally a surfactant having a hydrophilic and a hydrophobic part that would self-orientates at the surface of the substrate, reducing the surface tension of the liquid composition. Just as matter of example wetting agent can be chosen from sodium dodecylbenzenesulfonate, 4-octylbenzenesulfonic acid sodium salt, dodecane-1-sulfonic acid sodium salt and polyoxyethylene nonylphenyl ether.

Mixing of the copolymer (ZW-CA) with the crosslinking agent (CL), water and optionally, but preferably, additional components may be accomplished using any method well known to those skilled in the art.

In a second aspect, the present disclosure relates to a method for making frost resistant a substrate, the method comprising processing a composition (C), having all the possible features previously described, onto the substrate thereby providing a top coating layer (TL) effective to make said substrate frost resistant.

In some embodiments, the present disclosure relates to a method for making frost resistant a substrate, the method comprising:
(i) applying to the substrate a composition (C) comprising
   at least one copolymer [copolymer (ZW-CA)] comprising
      (a) repeating units [units (R_{ZW})] derived from at least one zwitterionic monomer [monomer (A)], and
      (b) repeating units [units (R_{CA})] derived from at least one carboxylic acid and/or carboxylic anhydride containing monomer [monomer (B)], and
   at least one crosslinking agent [crosslinking agent (CL)],
(ii) curing the composition (C) thereby obtaining a top coating layer (TL) effective to make said substrate frost resistant.

The composition (C) can have all the features previously disclosed in the description.

The substrate is typically in need of being made frost resistant.

In accordance with the present disclosure, generally a substrate in need of being made frost resistant is a substrate in contact with a gas medium comprising or consisting of water, typically moisture in the humid air, and whose surface temperature is below freezing point of water thus resulting in frost formation on said surface due to a phase change from water vapor (a gas) to ice (a solid) as the water vapor reaches the freezing point.

As used herein, the nature of top coating layer (TL) effective to make frost resistant a substrate depends on factors including the nature of the surface of the substrate; whether the aim is frost prevention, frost reduction or frost formation slow down; the contact time between the composition (C) and the surface; the curing temperature and the curing time; other additional components present in composition (C), and also the surface environment in question.

Generally step (i) is achieved using any method known to those of ordinary skill in the art. For example, the composition (C) can be applied by spray coating, spin coating, gravure coating, curtain coating, dip coating, slot-die coating, rod or bar coating, doctor-blade coating, flowcoating, which involves controlled gravity flow of a coating over the substrate, or the like.

Generally in step (ii) the coating composition (C) is allowed to dry at room temperature or may be dried at elevated temperature. A coated substrate having a top coating layer (TL) is typically prepared by curing the coating layer at a temperature of greater than 100° C., preferably at a temperature greater than 150° C. and more preferably greater than 200° C. Besides, the coating composition (C) is generally cured at less than 350° C., preferably less than 300° C. and more preferably less than 275° C.

In some embodiments, the coated substrate having a top coating layer (TL) is typically prepared by curing the coating layer at a temperature of greater than 100° C. and less than 350° C.; preferably of greater than 150° C. and less than 300° C. and more preferably of greater than 200° C. and less than 275° C.

As noted above, however, the curing temperature should be varied to suit the crosslinking agent included in the composition (C).

In some embodiments, the curing temperature as mentioned above represents the peak metal temperature (PMT). By peak metal temperature is meant the maximum temperature achieved by the metal substrate during the drying/curing process in a coil coating line.

Generally the curing time is greater than 2 seconds, preferably greater than 5 seconds and more preferably greater than 10 seconds. Besides, the curing time is generally less than 15 minutes, preferably less than 10 minutes and more preferably less than 5 minutes.

Generally the curing time ranges from 2 seconds to 15 minutes, preferably from 5 seconds to 10 minutes and more preferably from 10 seconds to 5 minutes.

In some embodiments, at least one curing catalyst is added to lower the curing temperature and/or to lower the curing time.

Without being bonded to any theory during curing the coating composition (C) is dried i.e. water, when present, is removed at least partially from the composition and crosslinking reaction occurs thus leading to a top coating layer (TL) which is hardened and crosslinked.

In some embodiments, the top coating layer (TL) effective to make frost resistant a substrate is such that it is deposited on the substrate in an amount ranging from 0.001 to 100 g/m², typically from 0.01 to 50 g/m², of the surface applied.

In some other embodiments, the top coating layer (TL) effective to make frost resistant a substrate is such that said top coating layer (TL) has a thickness ranging from 0.005 to 10 μm, typically from 0.01 to 5 μm.

Various substrates may be coated with the coating composition (C) of the invention. In some preferred embodiments, the substrate is a metal or metal-containing substrate, typically the metal is selected from the group consisting of iron, cast iron, copper, brass, aluminum, titanium, tin, carbon steel, stainless steel, and alloys thereof. Particularly preferred substrates are aluminum and steel. Most preferred substrate is aluminum.

In some other embodiments, the substrates that may be coated include plastic and paper.

Preferably, the substrate is pre-treated before coating to remove impurities and enhance the adhesion of coating compositions. For example, an aluminum substrate can be pre-treated by a degreasing agent, which has a concentration from 1% to 10% and pH from 11 to 13 for 30 seconds to 10 mins and then rinsed by water. The aluminum substrate is then dried under proper temperature, such as ambient temperature

In some preferred embodiments the substrate to be made frost resistant is coated with a base coating layer (BL) before processing the composition (C) to form the top coating layer (TL) effective to make said substrate frost resistant.

Accordingly, the resulting substrate is coated with double layer coating consisting of a base coating layer (BL) and a top coating layer (TL), wherein base coating layer (BL) is sandwiched between the substrate and the top coating layer (TL).

Generally, the base coating layer (BL) is obtained by processing a based coating composition (BC) onto the substrate.

Processing a composition (BC) onto a substrate to form base coating layer (BL) generally comprises.
(i) applying to the substrate the base coating composition (BC),
(ii) curing the base coating composition (BC) thereby obtaining a base coating layer (BL).

In some embodiments, the method for making frost resistant a substrate comprises:
(i) applying to the substrate a base coating composition (BC),
(ii) curing the base coating composition (BC) thereby obtaining a base coating layer (BL),
(iii) applying to the substrate coated with the base coating layer (BL) the coating composition (C) as previously described,
(iv) curing the coating composition (C) thereby obtaining a top coating layer (TL) effective to make frost resistant said substrate.

Generally steps (i) and (iii) are achieved using any method known to those of ordinary skill in the art previously described for composition (C).

Generally steps (ii) and (iv) are achieved using conditions previously described for top coating layer formed with composition (C).

In some preferred embodiments, the substrate to be made frost resistant is a metal or metal-containing substrate, typically wherein the metal is selected from the group consisting of iron, cast iron, copper, brass, aluminum, titanium, carbon steel, stainless steel, and alloys thereof coated with a base coating layer (BL).

In some more preferred embodiments, the substrate to be made frost resistant is a steel or aluminum substrate coated with a base coating layer (BL).

In some even more preferred embodiments, the substrate to be made frost resistant is an aluminum substrate coated with a base coating layer (BL).

Generally, the base coating composition (BC) comprises at least one polymer, the nature of which is not particularly limited as long as the base coating layer (BL) formed has anti-corrosion function. Anti-corrosion refers to the protection of substrates from corroding in high-risk (corrosive) environments.

The base coating composition (BC) may further comprise a catalyst, water, a cosolvent, a leveling agent, a lubricant, an aqueous toughening resin, a defoamer or a thickener.

For example, the base coating composition (BC) may comprise a water-borne resin, an aqueous crosslinking agent, a catalyst, a co-solvent, a leveling agent, a lubricant, an aqueous toughening resin, a defoamer, a thickener and water.

Preferably, the water-borne resin is selected from a group consisting of a water-borne acrylic resin, a water-borne modified acrylic resin, a water-borne epoxy resin, a water-borne modified epoxy resin and a water-borne polyester resin.

Preferably, the aqueous crosslinking agent is selected from a group consisting of an amino resin, an isocyanate, a silane coupling agent, a titanium coupling agent, a polycarboxylic acid and a polyamine.

Preferably, the catalyst is selected from a group consisting of p-toluenesulfonic acid, dodecylbenzenesulfonic acid, sulfamic acid, dinonylnaphthalene disulfonic acid and dinonylnaphthalenesulfonic acid.

Preferably, the co-solvent is selected from a group consisting of ethanol, n-butanol, tert-butanol, isobutanol, n-propanol, isopropanol, propylene glycol methyl ether, propylene glycol butyl ether, propylene glycol methyl ether acetate, dipropylene glycol methyl ether and dipropylene glycol methyl ether acetates.

Preferably, the leveling agent is selected from a group consisting of an acrylate leveling agent, an organic fluorocarbon leveling agent, an ether bond-containing compound capable of reducing surface tension and an amphiphilic group-containing compound capable of reducing surface tension.

Preferably, the lubricant is selected from a group consisting of a silicone emulsion, an organic fluorine emulsion, a wax emulsion, an aqueous fatty acid, an aqueous fatty acid amide, an aqueous fatty acid ester and an aqueous fatty acid metal soap. The lubricant can also be an organic silicone, organic fluorine, or a fatty acid modified water-borne resin.

Preferably, the aqueous toughening resin is selected from a group consisting of an aqueous polyester polyol, an aqueous polyamide, an aqueous styrene-butadiene emulsion, an aqueous polyethersulfone resin and an aqueous polyurethane.

Preferably, the defoaming agent is selected from a group consisting of a mineral oil defoaming agent, a polyether antifoaming agent, an organosiloxane defoaming agent and a polyether modified organosiloxane defoaming agent.

Preferably, the thickener is selected from a group consisting of a cellulose ether and a derivative thickener thereof, a polyacrylate thickener, a polyurethane thickener and a natural polymer and a derivative thereof.

It is also an object of the present invention to disclose an article comprising a metal or metal-containing surface, wherein the metal or metal-containing surface is coated with the top coating layer (TL) as previously described.

It is still an object of the present invention to disclose an article comprising a metal or metal-containing surface coated with the top coating layer (TL), wherein a base coating layer (BL) is sandwiched between the metal or metal-containing surface and the top coating layer (TL).

In an embodiment, the article is a part of a heating and/or cooling system, typically heat exchanger of air conditionings, refrigerators and other refrigerating plants.

The article of the present disclosure is prepared by the methods described herein. The features of the methods described herein apply to the article, mutatis mutandis.

In a fifth aspect, the present disclosure relates to a coating composition (C) that may have all the features previously described comprising
at least one copolymer (ZW-CA) comprising
   (a) repeating units (R_{ZW}) derived from at least one zwitterionic monomer (A), and
   (b) repeating units (R_{CA}) derived from at least one carboxylic acid and/or carboxylic anhydride containing monomer (B), and
at least one crosslinking agent (CL),
   wherein said crosslinking agent (CL) is a polyol.

Generally, polyol is selected from the list consisting of polyvinyl alcohol polymers i.e. homopolymers or copolymers, ethylene glycol, diethylene glycol, propylene glycol, neopentyl glycol, neopentyl glycol hydroxypivalate, cyclohexanedimethanol, butane-1,4-diol, pentane-1,5-diol, pentane-1,2-diol, hexane-1,6-diol, nonane-1,9-diol, glycerol, polyglycerol, trimethylolpropane, trimethylolpropane dimer, pentaerythritol, di pentaerythritol, xylitol, sorbitol, hydroxyalkylamides such as N,N,N′,N′-tetrakis(2-hydroxyethyl)hexanediamide, N,N,N′,N′-tetrakis(2-hydroxypropyl)hexanediamide, N,N,N′,N′-tetrakis(2-hydroxyethyl)butanediamide, N,N,N′,N′-tetrakis(2-hydroxypropyl)butanediamide, triethanolamine, triisopropanolamine, N,N,N′,N′-tetrakis(2-hydroxyethyl)ethylenediamine, N,N,N′,N′-tetrakis(2-hydroxypropyl)ethylenediamine, trimethylol melamine, dimethylolurea, 1,1,3-tris(hydroxymethyl)urea, 1,1,3,3-tetrakis(hydroxymethyl)urea, alkoxylated polyols such as pentaerythritol ethoxylate, pentaerythritol propoxylate, and mixtures thereof. Preferably polyol crosslinking agent is selected from the list consisting of N,N,N′,N′-tetrakis(2-hydroxyethyl)hexanediamide, N,N,N′,N′-tetrakis(2-hydroxypropyl)hexanediamide, N,N,N′,N′-tetrakis(2-hydroxyethyl)ethylenediamine, N,N,N′,N′-tetrakis(2-hydroxypropyl)ethylenediamine and mixtures thereof. Good results were obtained using N,N,N′,N′-tetrakis(2-hydroxyethyl)hexanediamide. Just for the sake of example, a suitable commercially available polyol is VESTAGON® EP-HA320 available from Evonik.

The present disclosures also relates to a coating composition (C) that may have all the features previously described comprising
at least one copolymer (ZW-CA) comprising
   (a) repeating units (R_{ZW}) derived from at least one zwitterionic monomer (A), and
   (b) repeating units (R_{CA}) derived from at least one carboxylic acid and/or carboxylic anhydride containing monomer (B), and
at least one crosslinking agent (CL),
   wherein said crosslinking agent (CL) is a polyisocyanate.

Generally polyisocyanate is selected from the list consisting of isophorone diisocyanate (IPDI), 1,4-phenylenedisocyanate, 1,4-diisocyanatobutane, hexane diisocyanates such as 1,6-diisocyanatohexane (HDI) and 1,5-diisocyanato-2-methylpentane (MPDI), 4,4′-methylenebis(cyclohexylisocyanate) (HMDI), heptane diisocyanates, octane diisocyanates, nonane diisocyanates such as 1,6-diisocyanato-2,4,4-trimethylhexane and 1,6-diisocyanato-2,2,4-trimethylhexane (TMDI), decane diisocyanates, undecane diisocyanates, dodecane diisocyanates, 4,4′-methylenebis(phenylisocyanate) (4,4′-MDI), 2,4-toluene diisocyanate (2,4-TDI), 2,6-toluene diisocyanate (2,6-TDI), 2,5(2,6)-bis(isocyanatomethyl)bicyclo[2.2.1]heptane (NBDI), 1,3-bis(isocyanatomethyl)cyclohexane (1,3-H₆-XDI), 1,4-bis(isocyanatomethyl)cyclo-hexane (1,4-H₆-XDI), nonane triisocyanates such as 4-isocyanatomethyl-1,8-octane diisocyanate (TIN), decane triisocyanates, undecane triisocyanates, dodecane triisocyanates and mixtures thereof.

The present disclosures also relates to a coating composition (C) that may have all the features previously described comprising
at least one copolymer (ZW-CA) comprising
   (a) repeating units (R_{ZW}) derived from at least one zwitterionic monomer (A), and
   (b) repeating units (R_{CA}) derived from at least one carboxylic acid and/or carboxylic anhydride containing monomer (B), and
at least one crosslinking agent (CL),
   wherein said crosslinking agent (CL) is a blocked polyisocyanate.

Examples of blocking compounds that may be used to prepare blocked isocyanates include, but are not limited to, phenols, alcohols, oximes such as, but not limited to, those obtained from methyl ethyl ketone, acetone and didisopropyl ketone, imidazole, 1,2-pyrazole, 3,5-dimethyl pyrazole (DMP), 1,2,4-triazole, benzotriazole, s-caprolactam, ethyl acetoacetate and diethyl malonate. Suitable blocked polyisocyanate can be obtained from polyisocyanate selected from the list previously disclosed. Just for the sake of example, a suitable commercially available blocked polyisocyanate is Bayhydur® BL XP 2706 available from Covestro, Imprafix® 2794 available from Covestro, Trixene® Aqua BI 200, Trixene® Aqua BI 201 and Trixene® Aqua BI 220 available from Lanxess, Aqualink® X, Aqualink® U and Aqualink® D-HT available from Aquaspersions, KL-1202, KL-1204, KL-1205 and KL-1206 available from Holdenchem.

In some embodiments, catalysts such as dibutyltin dilaurate (DBTL), cobalt or zinc acetylacetonate, diazabicyclo [2,2,2] octane (DABCO) or tetrabutylphosphonium bicarbonate can be added to composition (C) for accelerating the curing rate.

The present disclosures also relates to a coating composition (C) that may have all the features previously described comprising
at least one copolymer (ZW-CA) comprising
   (a) repeating units (R_{ZW}) derived from at least one zwitterionic monomer (A), and
   (b) repeating units (R_{CA}) derived from at least one carboxylic acid and/or carboxylic anhydride containing monomer (B), and
at least one crosslinking agent (CL),
   wherein said crosslinking agent (CL) is a polycarbodiimide.

Polycarbodiimides are generally synthesized through the reaction of polyisocyanates especially aliphatic or cycloaliphatic diisocyanates in the presence of a catalyst well known by the skilled person. Examples of polyisocyanates that may be used to prepare polycarbodiimides include, but are not limited to, isophorone diisocyanate (IPDI), 1,4-phenylenedisocyanate, 1,4-diisocyanatobutane, hexane diisocyanates such as 1,6-diisocyanatohexane (HDI) and 1,5-diisocyanato-2-methylpentane (MPDI), 4,4′-methylenebis(cyclohexylisocyanate) (HMDI), heptane diisocyanates, octane diisocyanates, nonane diisocyanates such as 1,6-diisocyanato-2,4,4-trimethylhexane and 1,6-diisocyanato-2,2,4-trimethylhexane (TMDI), decane diisocyanates, undecane diisocyanates, dodecane diisocyanates, 4,4′-methylenebis(phenylisocyanate) (4,4′-MDI), 2,4-toluene diisocyanate (2,4-TDI), 2,6-toluene diisocyanate (2,6-TDI), 2,5(2,6)-bis(isocyanatomethyl)bicyclo[2.2.1]heptane (NBDI), 1,3-bis(isocyanatomethyl)cyclohexane (1,3-H₆-XDI), 1,4-bis(isocyanatomethyl)cyclo-hexane (1,4-H₆-XDI), nonane triisocyanates such as 4-isocyanatomethyl-1,8-octane diisocyanate (TIN), decane triisocyanates, undecane triisocyanates, dodecane triisocyanates and mixtures thereof. The chain extending polycarbodiimides can be terminated e.g. by reacting with a monoisocyanate which may be alkyl, cycloalkyl, alkyl-aryl, or arylalkyl functional isocyanate, such as butylisocyanate, hexylisocyanate, octylisocyanate, undecylisocyanate, dodecylisocyanate, hexadecylisocyanate, octadecylisocyanate, cyclohexylisocyanate, phenylisocyanate, tolylisocyanate, 2-heptyl-3,4-bis(9-isocyanatononyl)-1-pentylcyclohexane or may be further functionalized by methods well known by the skilled person. Just for the sake of example, a suitable commercially available polycarbodiimide is Picassian®XL-702, Picassian®XL-721, Picassian®XL-732 and Picassian®XL-752 available from Stahl; Permutex® XR-13-554, Permutex® XR-5508, Permutex® XR-5577 and Permutex® XR-5580 also available from Stahl.

The applicants have found surprisingly that the coating composition (C) according to the present invention was suitable to prepare a top coating layer (TL) effective to delay frost formation on aluminum heat exchanger coated with a base coating layer (BL) having anti-corrosion function. Moreover they have found that surprisingly the top coating layer (TL) made from the coating composition (C) had very good adhesion onto the base coating layer (BL) and that the overall coating i.e. the double layer coating showed good resistance to corrosion and to scratch.

The methods and processes, including materials useful therefor, according to the present disclosure are further illustrated by the following non-limiting examples.

### EXAMPLES

### Materials

Acrylic acid, 2-(N-3-Sulfopropyl-N,N-dimethyl ammonium)ethyl methacrylate (SPE) and N,N,N′,N′-tetrakis(2-hydroxyethyl)hexanediamide were purchased from J&K Scientific, China. Sodium persulfate, sodium bisulfite, sodium dodecyl benzene sulfonate (SDBS), and ethylene glycol monobutylether (EGBE) were obtained from Sinopharm, China. Basecoat HD2805 was obtained from Guangzhou Human Chemicals Co. Ltd., China. Distilled water was used throughout the experiment.

### Characterization of (Co)Polymers

Gel permeation chromatography was performed at 35° C. using Malvern GPCmax with RID & SEC-MALS 20 equipped with columns (Waters Ultrahydrogel 120 and 120, 250 in series). The mobile phase was composed of 80% 0.1 M NaNO₃(aq) and 20% ACN, filtered with 0.22 μm filtration membrane, and the flow rate was of 0.8 mL/min. 100 μL samples were injected, and calibration was obtained with PEO standard solutions.

### Synthesis of Polyacrylic Acid Homopolymer (PAA)

In a reactor equipped with a condenser were added 190 g of water which were then heated and maintained at 85° C. under stirring. Then, were concomitantly added in the reactor within a duration of 3 hours—a solution A comprising 425 g of acrylic acid in 173 g of water—a solution B comprising 9.3 g of sodium persulfate in 173.2 g of water—a solution C comprising 70.3 g of sodium bisulfite in 131.7 g of water while maintaining the temperature at 85° C. and with stirring. After addition, the reaction medium was stirred for 1 more hour at 85° C. and then cooled to 50° C.

### Conversion≥97%.

Mw=3200 g/mol.

### Synthesis of poly(acrylic acid-co-N-(3-Sulfopropyl)-N-methacroyloxyethyl-N,N-dimethylammonium betaine) copolymer (P(AA-co-SPE))

In a reactor equipped with a condenser were added 190 g of water which were then heated and maintained at 85° C. under stirring. Then, were concomitantly added in the reactor within a duration of 3 hours—a solution A comprising 400 g of acrylic acid and 25.5 g of N-(3-Sulfopropyl)-N-methacroyloxyethyl-N,N-dimethylammonium betaine (SPE) in 173 g of water—a solution B comprising 9.3 g of sodium persulfate in 173.2 g of water—a solution C comprising 70.3 g of sodium bisulfite in 131.7 g of water while maintaining the temperature at 85° C. and with stirring. After addition, the reaction medium was stirred for 1 more hour at 85° C. and then cooled to 50° C.

Conversion AA≥97%; conversion SPE≥97%.
Mw=3300 g/mol.

Similar procedure was carried out for preparing P(AA-co-SPE) of different compositions. Results are reported in table 1 below.

TABLE 1
Synthesis of PAA and P(AA-co-SPE) polymers composition
of the reaction medium and Mw determined by GPC

| | (co)polymer | | | |
|---|---|---|---|---|
| | | P(AA-co- | P(AA-co- | P(AA-co- |
| composition | PAA | SPE6%) | SPE9%) | SPE12%) |
| Acrylic acid (g) | 425.5 | 400 | 387.3 | 374.5 |
| SPE (g) | 0 | 25.5 | 38.2 | 51.0 |
| Sodium persulfate (g) | 9.3 | 9.3 | 9.3 | 9.3 |
| Sodium bisulfite (g) | 70 | 70 | 70 | 70 |
| Water (g) | 495 | 495 | 495 | 495 |
| Monomers conversions (%) | ≥97 | ≥97 | ≥97 | ≥97 |
| MW (g/mol) | 3200 | 3300 | 3100 | 3100 |

### Preparation of Topcoat Formulations

From the (co)polymers obtained as described above in table 1, 4 topcoat formulations have been prepared, the compositions of which are reported in table 2 below.

TABLE 2
PAA and P(AA-co-SPE) based topcoat formulations

| | Formulation | | | |
|---|---|---|---|---|
| Composition | 1 | 2 | 3 | 4 |
| PAA (g) | 22 | 0 | 0 | 0 |
| P(AA-co-SPE6%) (g) | 0 | 21.7 | 0 | 0 |
| P(AA-co-SPE9%) (g) | 0 | 0 | 21.7 | 0 |
| P(AA-co-SPE12%) (g) | 0 | 0 | 0 | 21.8 |
| Hardener/Crosslinking agent | | | | |
| N,N,N′,N′-tetrakis(2- | 2 | 2 | 2 | 2 |
| hydroxyethyl)hexanediamide | | | | |
| (Vestagon ®EP-HA320) (g) | | | | |
| Wetting agent | | | | |
| Sodium dodecyl benzene sulfonate (SDBS) | 0.1 | 0.1 | 0.1 | 0.1 |
| (g) | | | | |
| Co-solvent | | | | |
| Ethylene glycol monobutyl ether (EGBE) (g) | 4 | 1 | 1 | 1 |
| Propylene glycol (PG) (g) | 0 | 3 | 3 | 3 |
| Water (g) | 71.9 | 73.2 | 72.2 | 72.1 |

### Preparation of Double-Layer Coatings on Aluminum Surfaces

All coatings were double layer coatings.

### Bar-Coating Process

A basecoat formulation of HD2805 was casted onto aluminum sheet surface using a 10 μm rod. Then, the resulting wet film was dried at 250° C. for 2 minutes, cooled up to ambiant temperature to give aluminum sheet coated with basecoat layer having anti-corrosion function. Formulations described in table 2 were casted onto aluminum sheet coated with basecoat layer using a 10 μm rod and the resulting wet films were dried at 250° C. for 2 minutes to give aluminum sheet double coated with basecoat and topcoat layers.

### Dip-Coating Process

Aluminum fin-tube heat exchanger was immersed into a 5% wt solution of degreasing agent for 5 minutes and then rinsed with deionised water for another 5 minutes before being dryied at room temperature. Degreased heat exchanger was further dipped into the formulation of basecoat for 5 minutesd lifted out the bath and dryied at 250° C. during 2 minutes. Heat exchanger coated with basecoat layer was then dipped into the formulation of topcoat described in table 2 for 5 minutes, lifted out the bath and dryied at 250° C. during 2 minutes to obtain aluminum heat exchanger double coated with basecoat and topcoat layers.

### Double-Layer Coatings Evaluation

A qualified coating should be kept intact i.e. without being swelled and/or detached and should keep its superhydrophilicity (SHL) in the long term especially in wet environment. Therefore, water dropping and soaking-in-water tests, the descriptions of which are described below, were conducted for quick evaluation of the hydrophilicity and durability of the potential candidates.

### Water Dropping Test

Hydrophilicity of the coatings was quickly evaluated by visual observation of water droplet of ˜0.02 ml spreading on the surface. Indeed it is conceptualized that surfaces with outstanding water spreading ability bring about frost delaying performances. Water droplet spreading was observed for coated surfaces obtained from formulations 1 to 4 giving evidence of hydrophilicity of the coatings.

### Water-Soaking Test

This test was conducted by immersing half of the coated aluminum sheet in distilled water for 100 h to visually assess the water resistance i.e. durability of the coating. Coated aluminum sheets obtained from formulations 1 to 4 were exempt of swelling, shrinkage or detachment.

### Neutral Salt Spray Test

Neutral salt spray test was performed to give corrosion resistance information for samples of aluminum (double-layer coated) coated with basecoat layer and further coated with topcoat layer made from formulations 1 to 4 in a standardized corrosive environment. For this purpose, samples were submitted to the fog generated by a 5% NaCl aqueous solution at 37° C. for 1000 h in a salt spray chamber. Examination of the samples after test revealed that less than 0.05% of the coated aluminum area was covered by impurities (corrosion), this level of contamination corresponding to a grade higher than grade 9.5 according to Japanese Standard Association JIS Z 2371, method of salt spray testing (2/20/2000). Samples of aluminum, coated with basecoat layer only, revealed a similar level of contamination corresponding to a grade higher than grade 9.5. It is important to note that pure PAA topcoat suffered the heaviest corrosion degree.

### Coatings Adhesion Test

Cross-cut test method was used to determine the resistance of the double-layer coatings to separation from the aluminum substrate using ASTM D3359 test Method B (2017). A cross-hatch pattern was made through the film to the aluminum sheet. Pressure sensitive tape is applied over the crosshatch cut after removal of detached flakes by brushing with a soft brush. Tape was then pulled off rapidly from the surface and adhesion of the coating was assessed by determination of the area of coating which was removed. The scale for this test ranges from 0 to 5, where 0 is when more than 65% area is removed and 5 is when 0% area is removed. The coatings according to the invention obtained evaluations from ASTM D3359 Class 5B.

TABLE 3
Cross-hatch test results

| | Polymer involved in | ASTM D3359 |
|---|---|---|
| Formulation | topcoat | Class |
| Base coat only | none | 5B |
| 1 | PAA | 5B |
| 2 | P(AA-co-SPE6%) | 5B |
| 3 | P(AA-co-SPE9%) | 5B |
| 4 | P(AA-co-SPE12%) | 5B |

Very good adhesion onto aluminum substrate was observed for base coating layer with class 5B obtained (see formulation base coat only in table 3). Adding a PAA topcoat to this base coating layer resulted in an overall coating having still very good adhesion onto said substrate (see formulation 1 in table 3, class 5B). Surprisingly, replacing PAA topcoat with P(AA-co-SPE) was not detrimental to the overall coating adhesion which remained class 5B (see formulations 2 to 4 in table 3).

### Anti-Frosting Performance Evaluation

To evaluate the frost-resisting performance, a fin-tube heat exchanger, assembled from aluminum fins installed on copper tubes and coated with base coat and top coat, was set up to measure its heat exchange capacity (Q).

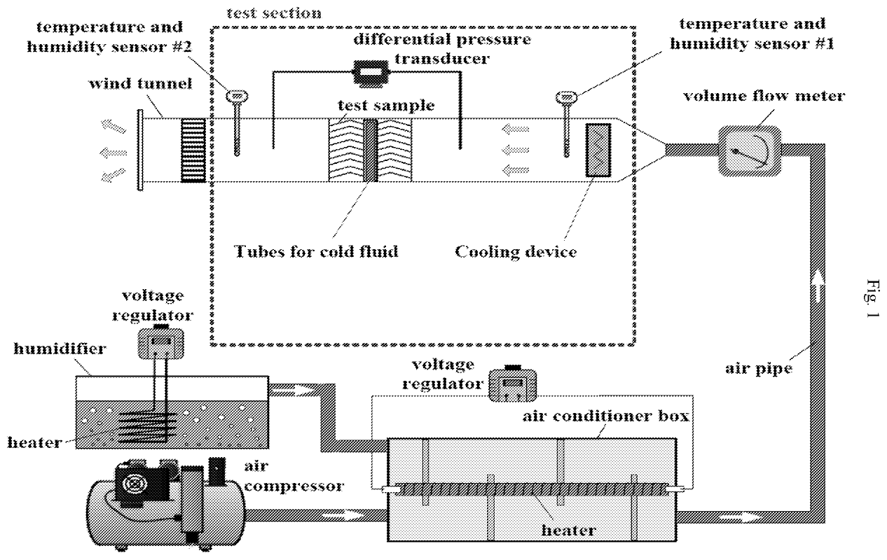

The facility employed to measure Q is shown in FIG. 1. This rig includes an air compressor, a humidifier, an air conditioner box, a volume flow meter and a transparent test section. The air compressor supplies the air flow, and the humidifier regulates the humidity of the moist air. The moist air temperature in the air conditioner box will be adjusted by the electrical heater regulated by a PID controller. The moist air is ventilated into the wind tunnel and blown through a cooling device (precooling heat exchanger) which cools down the air to a specific temperature (precooling at 7° C.) over the test sample. The test sample is cooled to subzero degrees Celsius using a subzero fluid which circulates through the tubes of test sample to set up the frosting condition. The volume flow rate, the temperature, the humidity and the pressure difference of the moist air are measured. Experimental data are acquired by Agilent Data Acquisition Instrument. The data acquisition records the relative humidity and temperature at the entry and exit of the test section, based on which the enthalpy change caused by test sample can be calculated. The heat transfer capacity is represented by heat transfer rate of test sample and is calculated from the enthalpy change. The equations are shown as below.

$${P}_{s} = \frac{2}{15} exp ( 18.5916 - \frac{3991.11}{T + 233.84} ) \qquad Eq ( 2 )$$

$$d = 0.622 \frac{{ϕ P}_{s}}{P - {ϕ P}_{s}} \qquad Eq ( 3 )$$

$${h}_{s} = 1.005 T + d ( 2501 + 1.86 T ) \qquad Eq ( 4 )$$

$${\dot{m}}_{in} = {\dot{m}}_{out} = ρ \dot{V} \qquad Eq ( 5 )$$

$$Q = {\dot{m}}_{in} {h}_{in} - {\dot{m}}_{out} {h}_{out} \qquad Eq ( 6 )$$

In the equations, T is the temperature measured in Celsius degrees.

Pₛ is the saturated pressure of water vapor in kPa.

ϕ is relative humidity.

d is moisture content with the unit of kg/kg.

hₛ represents the enthalpy of moist air with the unit of kJ/kg.

\dot{m}, ρ and \dot{V} are respectively air mass flow rate, air density and air volume flow rate, with unit of kg/h, kg/m³ and m³/h respectively.

The temperature of fin-tube heat exchanger is controlled to be −10° C. by cold fluid in copper tube. As real air-conditioners will automatically start defrosting when Q decreases to 80% Qmax, the key indicator of the frost-resisting performance is Δt, i.e. the duration time between arriving and leaving 80% of Qmax.

It is shown in table 4 that the frost-resisting performance of base coated aluminum surface top coated with crosslinked P(AA-co-SPE) is better than the frost-resisting performance of base coated aluminum surface top coated with crosslinked PAA when comparing their respective Δt values.

TABLE 4
Frost-resisting performance of fin-tube heat exchanger coated
with PAA and P(AA-co-SPE) based top coating layers.

| | Polymer involved in | |
|---|---|---|
| Formulation | topcoat | Δt (s) |
| 1 | PAA | 3000 |
| 2 | P(AA-co-SPE6%) | 6400 |
| 3 | P(AA-co-SPE9%) | 4850 |
| 4 | P(AA-co-SPE12%) | 5200 |

Results from table 4 clearly show that fin-tube heat exchanger top coated with crosslinked P(AA-co-SPE) copolymers are more resistant to frost formation than fin-tube heat exchanger top coated with crosslinked PAA. Accordingly, the beneficial effect of adding small amount of zwitterionic moieties in the top coating composition has been demonstrated.

The inventors have found that, replacing a top coat comprising crosslinked PAA by a top coat comprising crosslinked P(AA-co-SPE) was not only surprisingly effective to improve the frost resistance of fin-tube heat exchanger coated with a base coating layer having anti-corrosion function, but was also surprisingly effective to maintain a high level of adhesion of the overall coating onto the aluminum substrate while maintaining a high level of resistance to corrosive environment.

In other terms, the inventors have found that, replacing a top coat comprising crosslinked PAA by a top coat comprising crosslinked P(AA-co-SPE) was not only surprisingly effective to improve the durability of the heat transfer efficiency of the coated equipment, i.e. fin-tube heat exchanger, resulting in important energy saving, but was also surprisingly effective to maintain a high level of adhesion of the overall coating onto the aluminum substrate while maintaining a high level of resistance to corrosive environment.

1. A method of making frost resistant a substrate, the method comprising:
coating a substrate with a coating composition [composition (C)] comprising:
at least one copolymer [copolymer (ZW-CA)] comprising
(a) repeating units [units (R_{ZW})] derived from at least one zwitterionic monomer [monomer (A)], and
(b) repeating units [units (R_{CA})] derived from at least one carboxylic acid and/or carboxylic anhydride containing monomer [monomer (B)], and
at least one crosslinking agent [crosslinking agent (CL)].

2. The method according to claim 1, wherein the monomer (A) is selected from the groups consisting of
a) alkyl or hydroxyalkyl sulfonates or phosphonates of dialkylammonium alkyl acrylates or methacrylates, acrylamido or methacrylamido;
b) heterocyclic betaine monomers;
c) alkyl or hydroxyalkyl sulfonates or phosphonates of dialkylammonium alkyl allylics;
d) alkyl or hydroxyalkyl sulfonates or phosphonates of dialkylammonium alkyl styrenes;
e) betaines resulting from ethylenically unsaturated anhydrides and dienes;
f) phosphobetaines of formulae 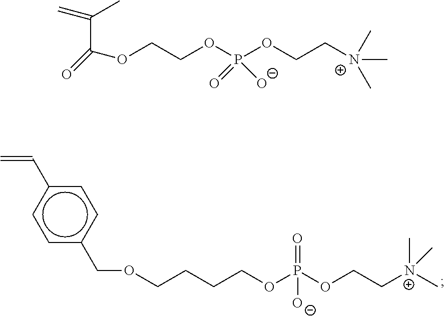
g) betaines resulting from cyclic acetals; and combinations thereof.

3. The method according to claim 1, wherein monomer (B) is selected from the group consisting of acrylic acid, methacrylic acid, maleic acid, maleic acid anhydride, itaconic acid, crotonic acid, fumaric acid, 4-methacryloxyethyltrimellitic acid, 4-methacryloxyethyltrimellitic acid anhydride, methacryloyl-L-Lysine, and combinations thereof.

4. The method according to claim 1, wherein copolymer (ZW-CA) further comprises repeating units [units (R_{N})], different from units (R_{ZW}) and (R_{CA}), derived from at least one monomer [monomer (D)] different from monomers A and B.

5. The method according to claim 4, wherein monomer (D) is selected from the group consisting of methyl methacrylate, ethyl methacrylate, n-butyl methacrylate, isobutyl methacrylate, 2-ethyl hexyl methacrylate, methyl acrylate, ethyl acrylate, n-butyl acrylate, isobutyl acrylate, 2-ethyl hexyl acrylate, vinyl acetate, 2-hydroxyethyl methacrylate (HEMA), hydroxypropyl methacrylate, 2-hydroxyethyl acrylate (HEA), hydroxypropyl acrylate, 4-hydroxybutyl acrylate, poly(ethylene glycol) methacrylate (PEGMA), poly(ethylene glycol) methyl ether methacrylate (mPEGMA), poly(ethylene glycol) ethyl ether methacrylate, poly(ethylene glycol) methyl ether acrylate, poly(ethylene glycol) ethyl ether acrylate, and combinations thereof.

6. The method according to claim 1, wherein the crosslinking agent (CL) is selected from the group consisting of polyols, polyamines, polyepoxides, polyisocyanates, blocked polyisocyanates, polycarbodiimides, and mixtures thereof.

7. The method according to claim 1, wherein composition (C) comprises water in an amount ranging from 5 wt. % to 90 wt. % of the total weight of said composition (C).

8. The method according to claim 1, wherein the substrate is a metal or metal-containing substrate.

9. A method for making frost resistant a substrate, the method comprising processing the composition (C) according to claim 1 onto the substrate thereby providing a top coating layer (TL) effective to make said substrate frost resistant.

10. An article comprising a metal or metal-containing surface, wherein the metal or metal-containing surface is coated with the coating composition (C) according to claim 1, thereby providing a top coating layer (TL) effective to make said metal or metal-containing surface frost resistant.

11. The article according to claim 10, wherein a base coating layer [coating layer (BL)] is sandwiched between the metal or metal-containing surface and the top coating layer (TL).

12. The article according to claim 10, wherein said article is part of a heating and/or cooling system.

13. A coating composition [composition (C)] comprising:
at least one copolymer [copolymer (ZW-CA)] comprising
(a) repeating units [units (R_{ZW})] derived from at least one zwitterionic monomer [monomer (A)], and
(b) repeating units [units (R_{CA})] derived from at least one carboxylic acid and/or carboxylic anhydride containing monomer [monomer (B)], and
at least one crosslinking agent [crosslinking agent (CL)],
wherein said crosslinking agent (CL) is a polyol.

14. The coating composition (C) according to claim 13, wherein the polyol is selected from the group consisting of polyvinyl alcohol polymers, ethylene glycol, diethylene glycol, propylene glycol, neopentyl glycol, neopentyl glycol hydroxypivalate, cyclohexanedimethanol, butane-1,4-diol, pentane-1,5-diol, pentane-1,2-diol, hexane-1,6-diol, nonane-1,9-diol, glycerol, polyglycerol, trimethylolpropane, trimethylolpropane dimer, pentaerythritol, di pentaerythritol, xylitol, sorbitol, N,N,N′,N′-tetrakis(2-hydroxyethyl)hexanediamide, N,N,N′,N′-tetrakis(2-hydroxypropyl)hexanediamide, triethanolamine, triisopropanolamine, N,N,N′,N′-tetrakis(2-hydroxyethyl)ethylenediamine, N,N,N′,N′-tetrakis(2-hydroxypropyl)ethylenediamine, trimethylol melamine, dimethylolurea, 1,1,3-tris(hydroxymethyl)urea, 1,1,3,3-tetrakis(hydroxymethyl)urea, alkoxylated polyols such as pentaerythritol ethoxylate, pentaerythritol propoxylate, and mixtures thereof.
